(19) United States
(12) Patent Application Publication
(10) Pub. No.: US 2009/0018843 A1
(43) Pub. Date: Jan. 15, 2009

(54) SPEECH PROCESSOR AND COMMUNICATION TERMINAL DEVICE

(75) Inventor: Takahiro KAWASHIMA, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi (JP)

(21) Appl. No.: 12/169,323

(22) Filed: Jul. 8, 2008

(30) Foreign Application Priority Data
Jul. 11, 2007 (JP) 2007-182458

(51) Int. Cl. G10L 11/00

(52) U.S. Cl. 704/278

(57) ABSTRACT

In a speech processor incorporated into a communication terminal device, an extractor extracts speech characteristics data (e.g. voiceprint data) from speech signals input thereto; then, a speech signal processing module processes input speech signals in accordance with signal processing parameters, which are stored in a memory in relation to preset speech characteristics data in advance. A parameter setting device selects one of preset speech characteristics data having a similarity with the extracted speech characteristics data so as to set the corresponding signal processing parameters stored in the memory to the speech signal processing module. Thus, the communication terminal device is capable of appropriately processing input speech signals so as to enhance specific ranges or to adjust the volume of input speech.

### BACKGROUND OF THE INVENTION

1. Field of the Invention

The present invention relates to speech processors for processing speech signals. The present invention also relates to communication terminal devices incorporating speech processors.

The present application claims priority on Japanese Patent Application No. 2007-182458, the content of which is incorporated herein by reference.

2. Description of the Related Art

Conventionally, various types of communication terminal devices such as telephones and cellular phones have been developed to incorporate speech processors, which adjust received speeches in an easy-to-hear state by automatically switching the quality of received speech in response to the telephone numbers of the counterpart communication terminals. This technology is disclosed in various documents such as Patent Document 1 and Patent Document 2.
Patent Document 1: Japanese Unexamined Patent Application Publication No. 2005-136788
Patent Document 2: Japanese Unexamined Patent Application Publication No. 2001-86200

In the aforementioned communication terminal devices, it is necessary to register adjusted conditions of received speeches with memories in response to telephone numbers; hence, upon reception of calls from communication terminals whose telephone numbers are unknown or have not been registered in advance, it is impossible to adjust received speeches. That is, conventionally-known communication terminal devices suffer from drawbacks in that they cannot always adjust received speech signals.

### SUMMARY OF THE INVENTION

It is an object of the present invention to provide a speech processor that is capable of appropriately adjusting and processing received speech signals.

It is another object of the present invention to provide a communication terminal device incorporating a speech processor, by which the quality of received speech is automatically adjusted.

In a first aspect of the present invention, a speech processor includes an extractor for extracting speech characteristics data (e.g. voiceprint data) from an input speech, a processor for processing the input speech in accordance with signal processing parameters set thereto, a memory for storing a plurality of preset speech characteristics data each corresponding to one of plural sets of signal processing parameters, and a parameter setting device for selecting one of the preset speech characteristics data, which has similarity with the extracted speech characteristics data, and for setting one set of signal processing parameters corresponding to the selected preset speech characteristics data to the processor.

The processor includes a high-pitch compensator, an enhancer, a dynamic range compressor, and an equalizer, for example.

The speech processor further includes a speech communicator for receiving speech signals from a counterpart communication terminal so as to produce speech signals, and a parameter editor for editing signal processing parameters in accordance with a user's instruction. Herein, the extractor extracts speech characteristics data representing characteristics of input speech from speech signals, so that the memory stores extracted speech characteristics data in relation to edited signal processing parameters.

In a second aspect of the present invention, a communication terminal device includes a speech communicator in addition to the aforementioned speech processor. The speech communicator performs communication with a counterpart communication device so as to receive speech signals.

According to the present invention, the extractor extracts one of preset speech characteristics data having a similarity with the extracted speech characteristics data, so that the corresponding signal processing parameters are set to the processor, thus appropriately processing input speech signals.

### BRIEF DESCRIPTION OF THE DRAWINGS

These and other objects, aspects, and embodiments of the present invention will be described in more detail with reference to the following drawings, in which:

FIG. 1 is a block diagram showing the constitution of a communication terminal device in accordance with a preferred embodiment of the present invention;

FIG. 2 is a block diagram showing the constitution of a speech signal processing module included in the communication terminal device shown in FIG. 1;

FIG. 3 is a table showing the relationship between voiceprint data and signal processing parameters, which are stored in a memory shown in FIG. 1;

FIG. 4A shows an example of signal processing parameters executed by a high-pitch compensator shown in FIG. 2;

FIG. 4B shows an example of signal processing parameters executed by an enhancer shown in FIG. 2;

FIG. 4C shows an example of signal processing parameters executed by a dynamic range compressor shown in FIG. 2;

FIG. 4D shows an example of signal processing parameters executed by an equalizer shown in FIG. 2;

FIG. 5 is a flowchart showing speech signal processing executed by the communication terminal device shown in FIG. 1; and

FIG. 6 is a flowchart showing a voiceprint data registration process for registering voiceprint data with memory in connection with signal processing parameters.

### DESCRIPTION OF THE PREFERRED EMBODIMENT

The present invention will be described in further detail by way of examples with reference to the accompanying drawings.

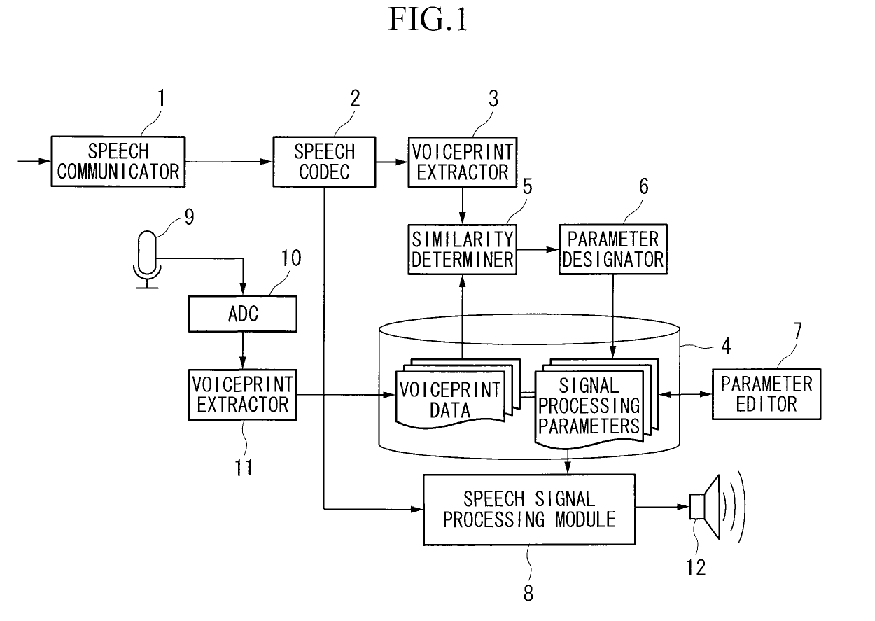

FIG. 1 is a block diagram showing the constitution of a communication terminal device (e.g. a cellular phone) in accordance with a preferred embodiment of the present invention, wherein it shows parts regarding speech processing only, hence, other parts are not shown for the sake of convenience.

A speech communicator 1 performs communication with a counterpart communication terminal (not shown) so as to receive speech signals. A speech codec (i.e., a speech coder-decoder) 2 is a module that converts (or decodes) coded speech signals output from the speech receiver 1 into linear audio signals. As the coding method of audio signals, it is possible to name QCELP (Qualcomm Code Excited Linear Prediction) and AMR (Advanced Multi Rate Codec).

A voiceprint extractor 3 analyzes linear speech signals output from the speech codec 2 so as to extract voiceprint data (or speech characteristics data) representing the characteristics of speech signals. Voiceprint data are detected by way of the long-time spectrum analysis method, for example. That is, frequency analysis using FFT (i.e. Fast Fourier Transform) is consecutively performed on speech signals in units of time intervals; then, detected values of frequencies are accumulated. It is continuously performed in a prescribed number of time intervals (or a prescribed number of times performing accumulation); then, the accumulated values of frequencies are divided by the prescribed number, thus producing voiceprint data.

A memory 4 stores preset voiceprint data (preset speech characteristics data) in relation to signal processing parameters (defining the contents of processing performed by a speech signal processing module 8) in advance. A similarity determiner 5 determines similarities between the preset voiceprint data and the extracted voiceprint data (extracted by the voiceprint extractor 3). Various methods can be used to determine similarities. For example, merkepstrum analysis is performed so as to produce time-series characteristic vectors, distances of which are calculated so as to determine similarities.

A parameter designator (or a parameter setting device) 6 selects voiceprint data having a high similarity with the extracted voiceprint data (extracted by the voiceprint extractor 3) from among preset voiceprint data stored in the storage 4 based on the determination result of the similarity determiner 5, and then it reads the signal processing parameters from the storage 4, thus designating (or setting) the selected voiceprint data for the speech signal processing module 8. A parameter editor 7 edits signal processing parameters in response to user's instruction, which the user designates by operating keys of the communication terminal device (not shown) in association with GUI (Graphical User Interface) functions on a display (not shown). The parameter editor 7 is not necessarily incorporated in the communication terminal device; hence, the function thereof can be achieved by an external device such as a personal computer that is connected to the communication terminal device via the interface thereof (not shown). The speech signal processing module 8 performs processing whose contents are designated by the parameter designator 6 with respect to speech signals output from the speech codec 2. This improves the sound quality, and this makes it easy for the user to hear the received speech.

A microphone 9 converts speech into analog speech signals. An A/D converter (or ADC) 10 converts analog speech signals (output from the microphone 9) into digital speech signals. Similar to the voiceprint extractor 3, a voiceprint extractor 11 analyzes digital speech signals (output from the A/D converter 10) so as to extract voiceprint data (or speech characteristics data) therefrom. Extracted voiceprint data (extracted by the voiceprint extractor 11) is stored in the memory 4 together with signal processing parameters edited by the parameter editor 7. A speaker 12 produces speech (or sound) based on speech signals (or audio signals) processed by the speech signal processing module 8.

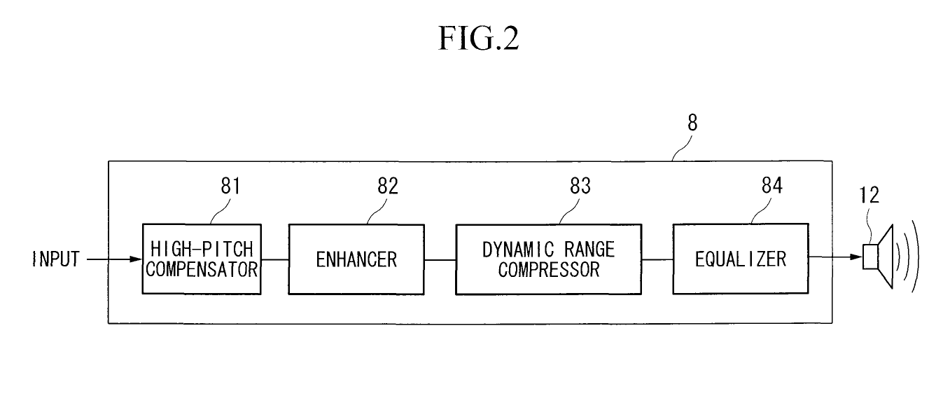

FIG. 2 is a block diagram showing the constitution of the speech signal processing module 8. A high-pitch compensator 81 compensates for high pitches of speech signals, which are lost due to band limitation of the speech codec 2. In addition, the high-pitch compensator 81 performs prescribed processing so as to reduce (or eliminate) roughness of speech. An enhancer 82 enhances high-pitch overtones with respect to speech signals output from the high-pitch compensator 81, thus creating lively speech (in other words, making speech clear in hearing).

A dynamic range compressor (DRC) 83 dynamically damps high signal levels (which exceed a specific level or threshold) with respect to speech signals output from the enhancer 82. When an input speech has a high volume, it is depressed in volume so as to increase the volume in all ranges, thus achieving uniform volume in all ranges. Even when the enhancer 82 increases the peak volume, it is possible to produce the desired speech, which has an adequate volume and which does not include distortions. An equalizer (EQ) 84 corrects the frequency bands of speech signals in units of bands. The parameter designator 6 designates appropriate signal processing parameters for the high-pitch compensator 81, the enhancer 82, the dynamic range compressor 83, and the equalizer 84 in the speech signal processing module 8, thus achieving designated signal processing.

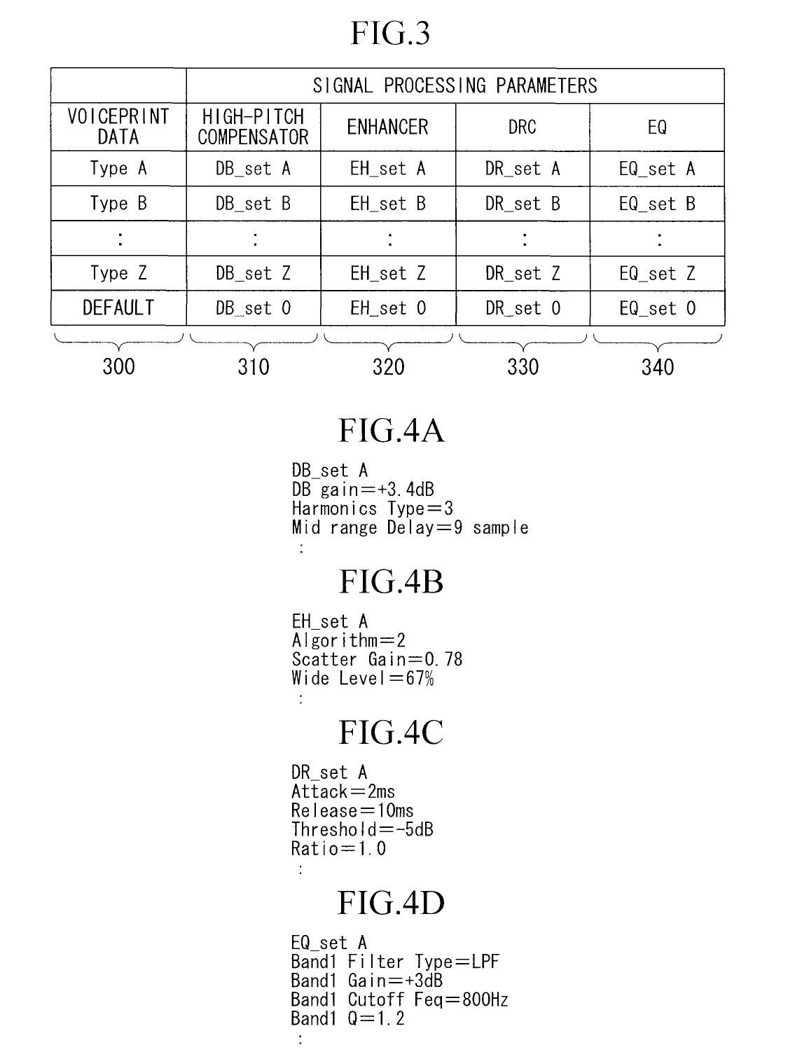

FIG. 3 shows the relationship between voiceprint data and signal processing parameters, which are stored in the memory 4. Specifically, voiceprint data 300 corresponds to signal processing parameters 310 (see FIG. 4A) defining the processing of the high-pitch compensator 81, signal processing parameters 320 (see FIG. 4B) defining the processing of the enhancer 82, signal processing parameters 330 (see FIG. 4C) defining the processing of the dynamic range compressor 83, and signal processing parameters 340 (see FIG. 4D) defining the processing of the equalizer 84.

For example, voiceprint data “Type A” corresponds to a statement “DB_set A” defining the signal processing parameters 310 (see FIG. 4A), a statement “EH_set A” defining the signal processing parameters 320 (see FIG. 4B), a statement “DR_set A” defining the signal processing parameters 330 (see FIG. 4C), and a statement “EQ_set A” defining the signal processing parameters 340 (see FIG. 4D).

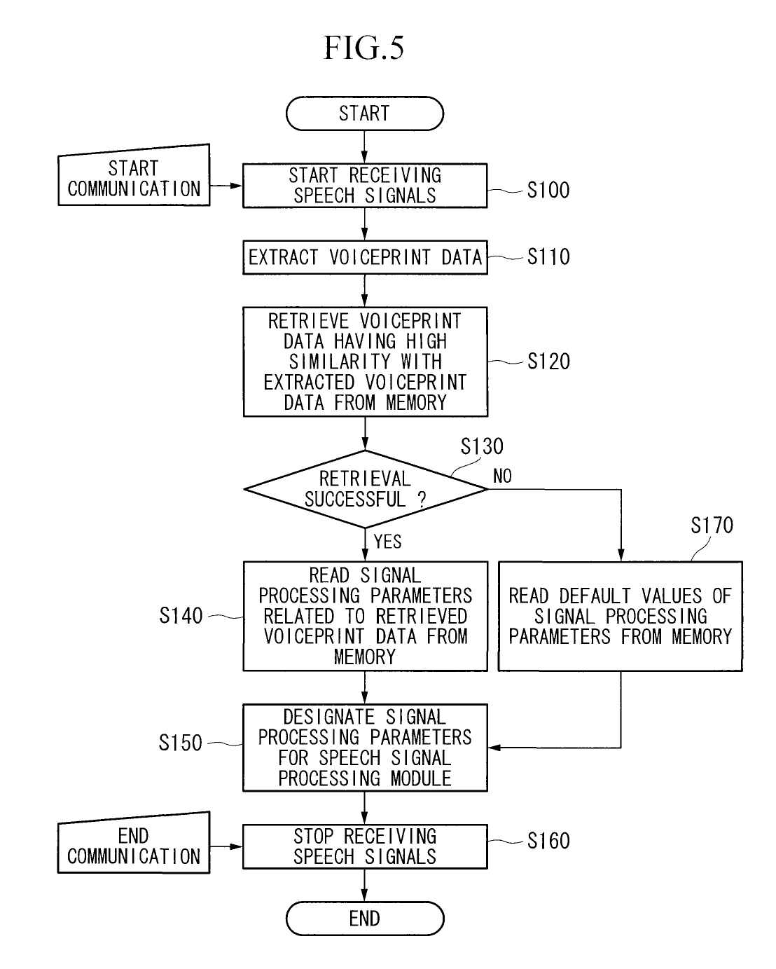

Next, speech signal processing during communication with a counterpart communication terminal will be described with reference to FIG. 5. Communication is established between the communication terminal device and the counterpart communication terminal when the user operates the communication terminal device so as to issue a dial call towards the counterpart communication terminal, or when the communication terminal device receives a dial call from the counterpart communication terminal. The speech communicator 1 receives speech signals, which are coded and are then forwarded to the speech codec 2. The speech codec 2 converts coded speech signals into linear speech signals in step S100. In step S110, the voiceprint extractor 3 extracts voiceprint data from speech signals.

The similarity determiner 5 determines the similarity between the extracted voiceprint data (extracted by the voiceprint extractor 3) and the preset voiceprint data stored in the memory 4 in advance. Based on the result of the similarity determination, the parameter designator 6 retrieves the voiceprint data having a high similarity with the extracted voiceprint data from the multiple preset voiceprint data stored in the memory 4 in step S120; in other words, it retrieves one of the multiple present voiceprint data whose similarity with the extracted voiceprint data is higher than a prescribed threshold.

When the parameter designator 6 successfully retrieves voiceprint data whose similarity is higher than the prescribed threshold, the decision result of step S130 turns to “YES”, so that the flow proceeds to step S140. When it cannot retrieve voiceprint data whose similarity is higher than the prescribed threshold, the decision result of step S130 turns to “NO”, so that the flow proceeds to step S170.

In step S140, the parameter designator 6 reads the signal processing parameters related to the retrieved voiceprint data having a highest similarity with the extracted voiceprint data from the memory 4. In step S70, the parameter designator 6 reads the default values of the signal processing parameters, which are prepared in advance, from the memory 4. After completion of the step S140 or the step S170, the flow proceeds to step S150 in which the parameter designator 6 designates the read signal processing parameters for the speech signal processing module 8.

Until the end of communication, the speech signal processing module 8 retains the signal processing parameters (obtained in the step S140 or the step S170). Alternatively, the flowchart of FIG. 5 can be partially modified in such a way that the flow automatically returns to step S100 every prescribed time so as to secure an adequate level of easy-to-hear state even when the talker changes during communication with the counterpart communication terminal. At the end of communication, the communication terminal device stops receiving speech signals in step S160. Thus, a series of operations regarding the speech signal processing is ended.

As described above, voiceprint data having a similarity with voiceprint data extracted from received speech signals (sent from the counterpart communication terminal) is retrieved from among multiple preset voiceprint data stored in the memory 4; then, signal processing parameters related to the retrieved voiceprint data are set to the speech signal processing module 8; hence, it is possible to perform appropriate speech signal processing with respect to received speech signals. Even when the communication terminal device receives a first call from an unknown communication terminal, it is possible to perform appropriate speech signal processing with respect to received speech signals if the memory 4 stores voiceprint data having a similarity with extracted voiceprint data extracted from received speech signals.

The present embodiment is designed to supply the speech signals processing module 8 with optimum signal processing parameters suited to a voiceprint (or voice characteristics) of a person who calls using the counterpart communication terminal, thus making it possible for the user of the communication terminal device to easily hear the received speech. That is, the present embodiment offers outstanding effects in which the received speech of a relatively low volume can be enhanced in volume, and thick voice can be softened in tone.

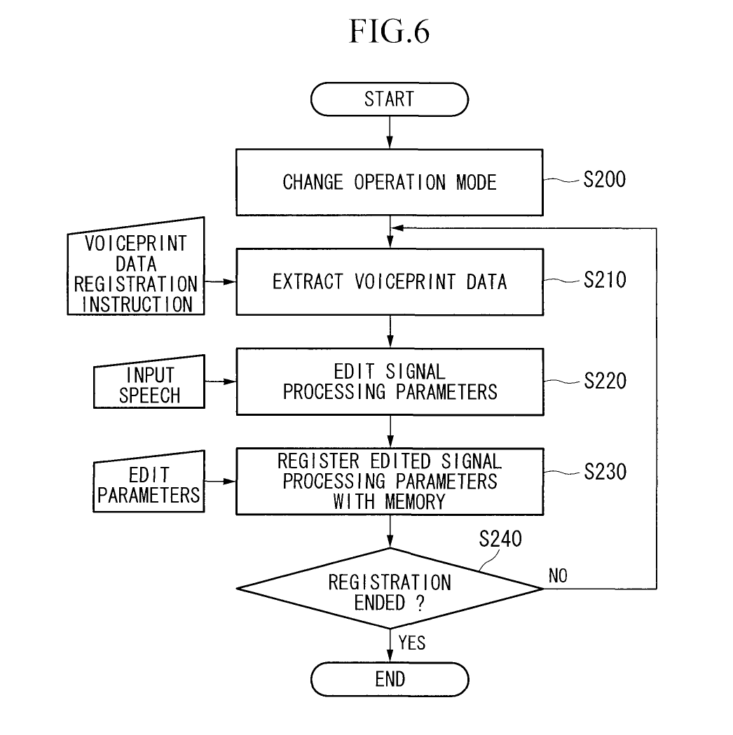

Next, a voiceprint data registration process for registering voiceprint data with the memory 4 will be described with reference to FIG. 6. In step S200, the user changes an operation mode of the communication terminal device, thus allowing the communication terminal device to register voiceprint data with the memory 4. Subsequently, the microphone 9 picks up speech input thereto so as to produce analog speech signals, which are then forwarded to the A/D converter 10. The A/D converter 10 converts analog speech signals into digital speech signals. The voiceprint extractor 11 analyzes digital speech signals so as to extract voiceprint data I step S210. The extracted voiceprint data are stored in the memory 4.

Subsequently, the user operates the communication terminal device so as to edit signal processing parameters. That is, the user uses GUI functions so as to edit signal processing parameters to suite the extracted voiceprint data (corresponding to the input speech). In step S220, the parameter editor 7 edit signal processing parameters as described above. In step S230, the parameter editor 7 stores the edited signal processing parameters in the memory 4 in relation to voiceprint data, which are extracted by the voiceprint extractor 11 and are then stored in the memory 4.

When the user intends to continue registering voiceprint data with the memory 4, in other words, when the decision result of step S240 is “NO”, the flow returns to step S210 so as to repeat the aforementioned processes. When the user operates the communication terminal device so as to stop registering voiceprint data with the memory 4, in other words, when the decision result of step S240 is “YES”, the voiceprint data registration process is ended.

Lastly, the present invention is not necessarily limited to the present embodiment, which can be further modified in a variety of ways within the scope of the invention as defined in the appended claims.

What is claimed is:

1. A speech processor comprising:
an extractor for extracting speech characteristics data from an input speech;
a processor for processing the input speech in accordance with signal processing parameters set thereto;
a memory for storing a plurality of preset speech characteristics data each corresponding to one of plural sets of signal processing parameters; and
a parameter setting device for selecting one of the plurality of preset speech characteristics data, which has a similarity with the extracted speech characteristics data and for setting one set of signal processing parameters corresponding to the selected preset speech characteristics data to the processor.

2. A speech processor according to claim 1 further comprising a speech communicator for receiving the speech signals input thereto so as to produce speech signals and a parameter editor for editing the signal processing parameters in accordance with a user's instruction, wherein the extractor extracts the speech characteristics data representing characteristics of the input speech from the speech signals, and wherein the memory stores the extracted speech characteristics data in relation to the edited signal processing parameters.

3. A communication terminal device comprising:
a speech communicator for performing communication with a counterpart communication device so as to receive speech signals; and
a speech processor, which includes
an extractor for extracting speech characteristics data from the speech signals,
a processor for processing the speech signals in accordance with signal processing parameters set thereto,
a memory for storing a plurality of preset speech characteristics data each corresponding to one of plural sets of signal processing parameters, and
a parameter setting device for selecting one of the plurality of preset speech characteristics data, which has a similarity with the extracted speech characteristics data and for setting one set of signal processing parameters corresponding to the selected preset speech characteristics data to the processor.

4. A speech processor according to claim 1, wherein the processor include at least one of a high-pitch compensator, an enhancer, a dynamic range compressor, and an equalizer.

5. A speech processor according to claim 4, wherein the signal processing parameters defines a content of processing regarding one of the high-pitch compensator, the enhancer, the dynamic range compressor, and the equalizer.

6. A speech processor according to claim 1, wherein the parameter setting device sets default values of the signal processing parameters, which are prepared in advance, to the processor when the memory does not store preset speech characteristics data having a similarity with the extracted speech characteristics data.

7. A speech processor according to claim 1, wherein the speech characteristics data is voiceprint data.

8. A communication terminal device according to claim 3, wherein the speech characteristics data is voiceprint data.
